(19) United States
(12) Patent Application Publication
(10) Pub. No.: US 2004/0012977 A1
(43) Pub. Date: Jan. 22, 2004

(54) Automobile exhaust pipe perforated diaphaneity dazzling structure

(76) Inventor: Polo Hou, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/196,134

(22) Filed: Jul. 17, 2002

(51) Int. Cl. F21V 33/00

(52) U.S. Cl. 362/545; 362/543; 362/253; 362/800

(57) ABSTRACT

An automobile exhaust pipe tail diaphaneity dazzling structure provides an outer tube, an inner tube and a circuit board. A plurality of concave light convergence areas are provided on the outer tube with a gap each formed at where the light convergence area breaks away from the outer tube. The circuit board is fixed between the outer and the inner tubes and provides a plurality of light emitting diodes thereon. When the light emitting diodes are turned on, they give dazzling decoration effects to the exhaust pipe particularly during driving at night to alert approaching vehicles to achieve dual purposes of attractive appearance and safety.

### BACKGROUND OF THE INVENTION

(a) Field of the Invention

The present invention is related to a perforated diaphaneity dazzling structure adapted to an exhaust pipe of an automobile; and more particularly, to a plurality of gaps each adapted to a corresponding light convergence area provided in concave on the flange of the exposed end of the exhaust pipe; so that when a plurality of light emitting diodes on the circuit board flare, they create dazzling for decoration purpose while warning the approaching vehicles to achieve dual purposes of safety and attraction

(b) Description of the Prior Art

As illustrated in FIG. 6A, a tail section (B) is usually available to be mounted to an exhaust pipe (A) of an automobile. The tail section (B) is essentially comprised of a hollow outer tube (B1) containing an inner tube (B2) fixed in position to the outer tube (B1) by means of a plurality of fixation bolts (B3) and the inner tube (B2) is again fixed to the exhaust pipe (A) by means of fixation bolts (B3) for reduction of noise and waste gas while preventing ingression of water containment or foreign matter. However, the styling of the tail section (B) is not attractive and without any creativity to become a burden to the appearance of the automobile in general. Furthermore, the function of the tail section (B) is limited since it does not provide any alert purpose.

### SUMMARY OF THE INVENTION

The primary purpose of the present invention is to provide a tail section that converges the light to reinforce reflection so that when an automobile is driving at night, the tail section is lighted in a dazzling fashion to warn an approaching vehicle for achieving the dual purposes of safety and attraction. To achieve the purpose, a perforated diaphaneity dazzling structure is mounted to the flange of the tail of the exhaust pipe.

### BRIEF DESCRIPTION OF THE DRAWINGS

FIG. 1 is an exploded view of a preferred embodiment of the present invention.

FIG. 2 is a sectional view of the preferred embodiment of the present invention.

FIG. 3 is a view showing a light convergence area of the preferred embodiment of the present invention.

FIG. 4 is a sectional view showing that the preferred embodiment of the present invention in operation.

FIG. 5 a perspective view of a light convergence area of another preferred embodiment of the present invention.

FIG. 6 is a sectional view of a prior art.

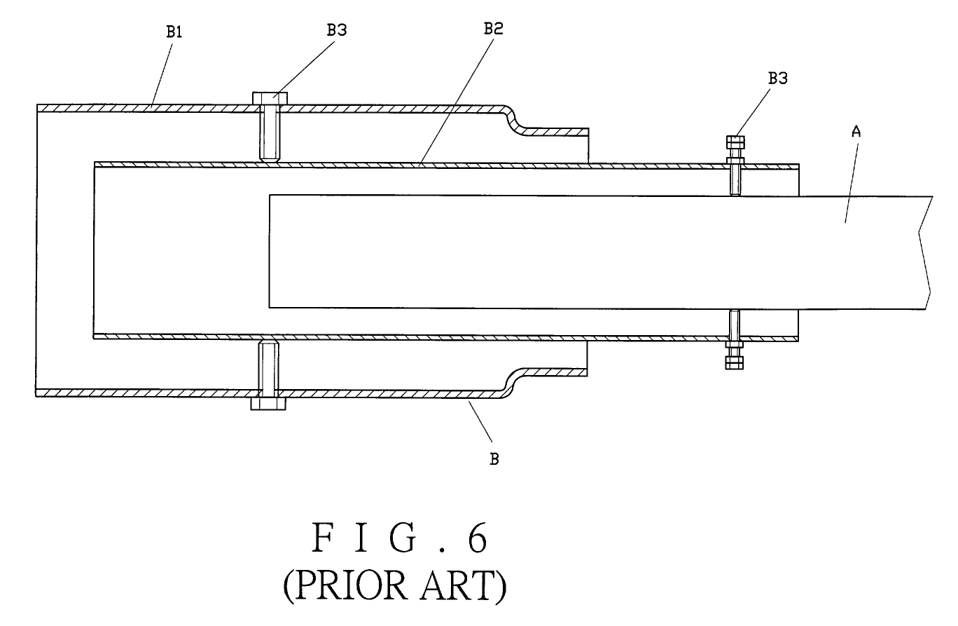

### DETAILED DESCRIPTION OF THE PREFERRED EMBODIMENTS

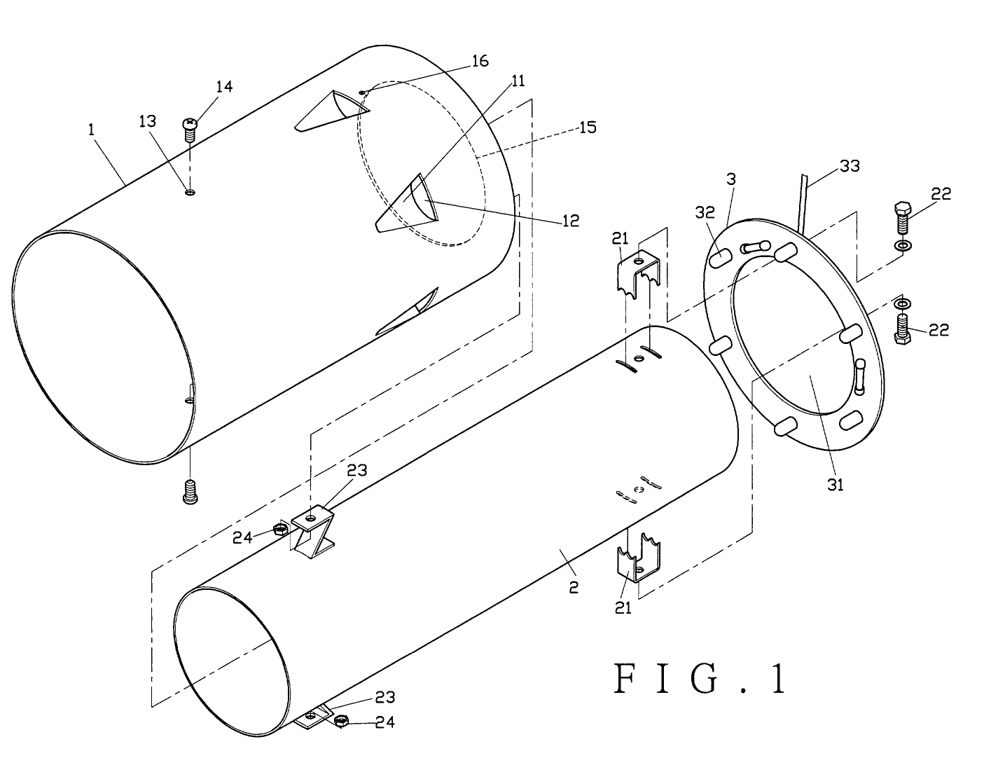

Referring to FIG. 1, a preferred embodiment of the present invention is essentially comprised of an outer tube (1), an inner tube (2) and a circuit board (3).

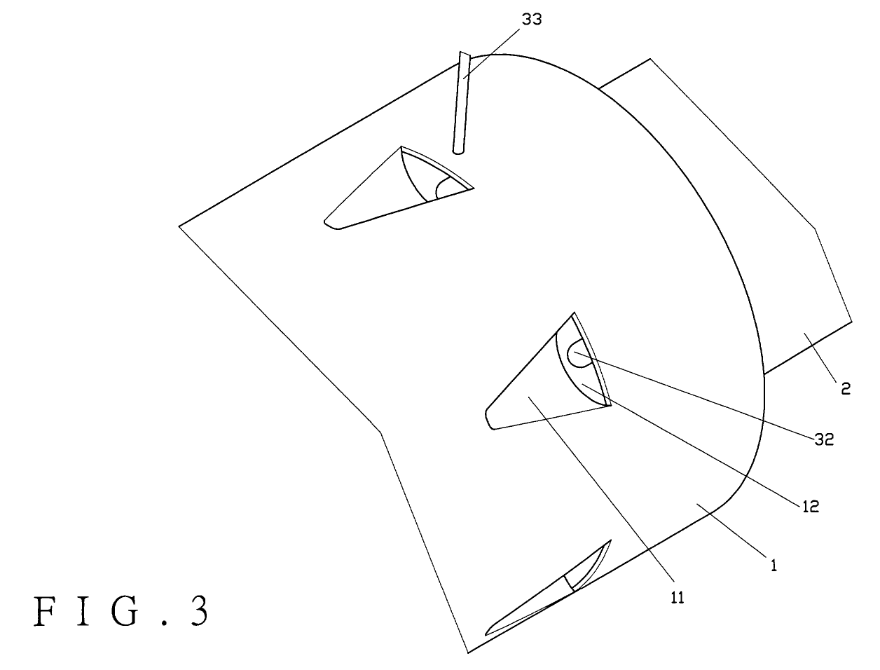

As illustrated in FIG. 3, the outer tube (1), made of stainless steel or any other materials that yield strong reflectivity property, is provided with a plurality of light convergence areas (111) in concave on its flange. The light convergence areas (11) each in conic or arc may be formed by punching, casting or any other proper process. One end of the light convergence area (11) breaks away from the wall of the outer tube (1) to form a gap (12). A plurality of screw holes (13) are provided near the rear end of the outer tube (1) to receive insertion of screws (14). A lip (15) is provided at the front end of the outer tube (1) and a penetrating hole (16) is provided through the wall of the outer tube (1).

The inner tube (2) is inserted into the outer tube (1) and has a plurality of clamps (21) at the front end. Each of the clamps (21) is fixed with a bolt (22). A plurality of Z-shaped fixation tabs (23) and nuts (24) are provided at the rear end of the inner tube (2).

The circuit board (3) fixed between the inner tube (2) and the outer tube (1) is a ring shape with a circular opening (31) and provides with a plurality of light emitting diodes (32). Each of the light emitting diodes (32) is located at the gap (12) of the light convergence area (11) of the outer tube (1). The circuit board (3) provides a power line (33).

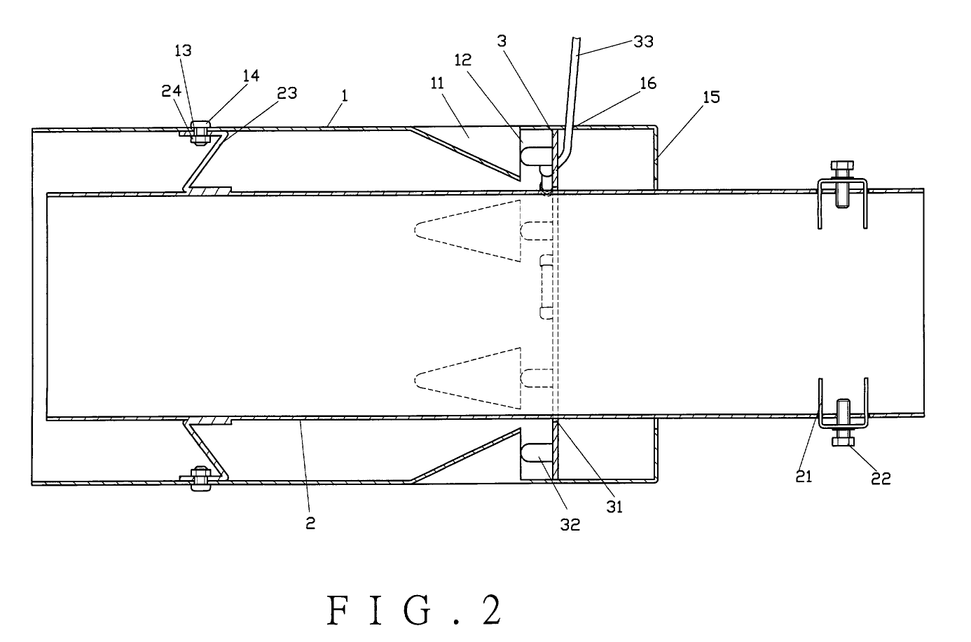

Referring to FIG. 2, the circuit board (3) is adhered to the inner wall of the outer tube (1) with each of the light emitting diodes (32) of the circuit board (3) aligned at the gap (12) of the corresponding light convergence area (11), as illustrated in FIG. 3. The light from the light emitting diodes (32) emits through the gaps (12). The power line (33) of the circuit board (3) passes through the penetrating hole (16) of the outer tube (1), and then the inner tube (2) passes through the opening (31) of the circuit board (3) to be contained inside the outer tube (1) for the circuit board (3) to be located between the outer wall of the inner tube (2) and the inner wall of the outer tube (1). The nuts (24) on the fixation tabs (23) of the inner tube (2) are aligned to the screw holes (13) of the outer tube (1), and the screws (14) are inserted through the screw holes (13) to secure the fixation tabs (23) of the inner tube (2) to complete the assembly of the outer tuber (1) and the inner tube (2).

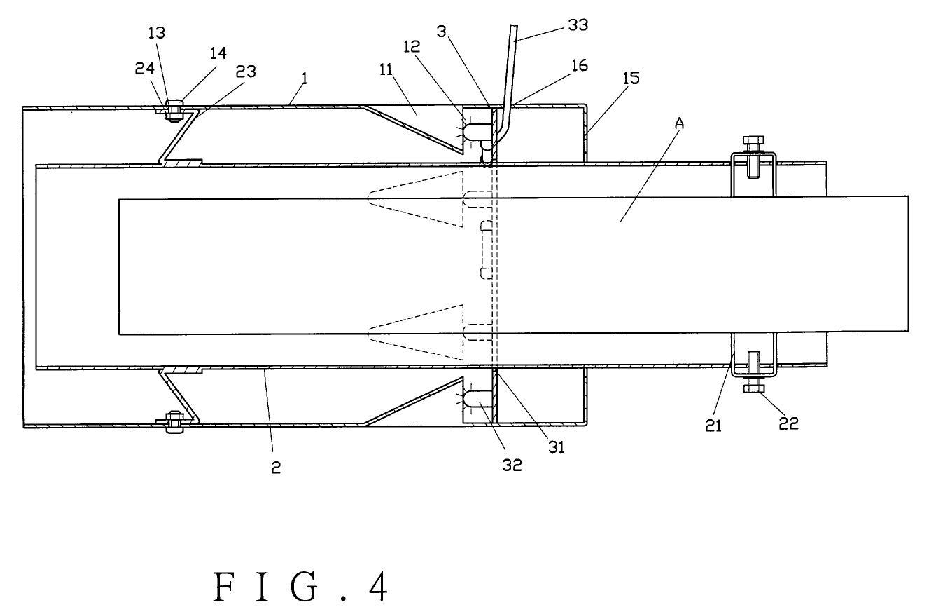

As illustrated in FIG. 4, an exhaust pipe (A) is inserted into the inner tube (2) with the clamps (21) of the inner tube (2) to retain the outer wall of the exhaust pipe (2). The bolts (22) attached to the clamp (21) are then tightened up for the exhaust pipe (A) to be secured by the clamps (21). The power line (33) of the circuit board (3) is connected to the source of an automobile or to a controller of a signal light and a brake light. Thus, the light emitting diodes (32) of the circuit board (3) are either kept always lighted or when the signal light and/or the brake light is turned on. Once the light emitting diodes are on, the light emits through the gaps (12) in the light convergence areas (11) of the outer tube (1). Intensity and reflection of the light are both significantly improved at the light convergence areas (11) since the outer tube (1) is made of reflective material and in conic or arc. Accordingly, during driving at night or the signal light or the brake light is turned on, the dazzling flare of the present invention can be clearly seen by those drivers in any approaching cars from both sides or behind.

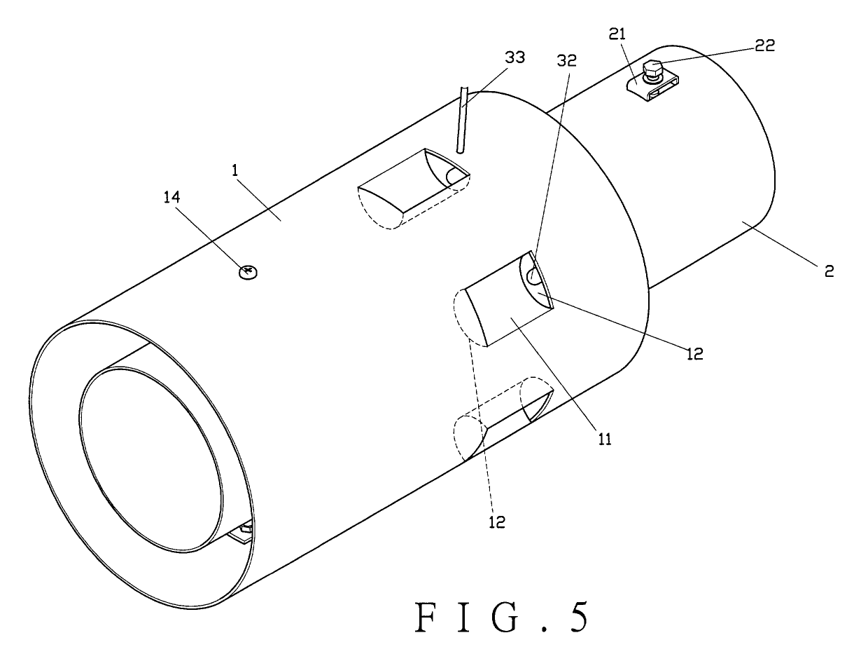

FIG. 5 shows another preferred embodiment of the present invention. A plurality of light convergence areas (11) are provided in concave on the flange of the outer tube (1). The light convergence area (11) can be made in conic or arc by punching, casting or other proper process with both ends respectively formed a gap (12) at where the light convergence area (11) breaks away from the wall of the outer tube (1) to achieve both of alert and decoration purposes.

As disclosed above, advantages of the present invention are summarized as follows:

1. Flaring light emitting diodes on the circuit board of the present invention by providing dazzling decoration effects to the exhaust pipe particularly during driving at night to alert the approaching vehicles achieve dual purposes of attractive appearance and safety.

2. Intensity and reflection of the light are both significantly improved at the light convergence areas since the outer tube is made of reflective material and in conic or arc.

I claim:

1. An automobile exhaust pipe tail diaphaneity dazzling structure essentially comprised of an outer tube, an inner tube and a circuit board; wherein, said outer tube being fixed to an outer flange of said inner tube; a plurality of clamps and fixation tabs being provided to said inner tube; and said circuit board being a ring shape and fixed between said inner tuber and said outer tube, and a plurality of light emitting diodes being provided on said circuit board; characterized by that:
a plurality of concave light convergence areas corresponding to said light emitting diodes being provided on said outer tube, one end of each of said light convergence area being formed with a gap at where said light convergence area breaks away from said outer tube while each light emitting diode being located at said gap.

2. An automobile exhaust pipe tail diaphaneity dazzling structure as claimed in claim 1, wherein, said outer tube is made of stainless steel or any other material providing strong reflectivity.

3. An automobile exhaust pipe tail diaphaneity dazzling structure as claimed in claim 1, wherein, a lip is provided to a front end of said outer tube.

4. An automobile exhaust pipe tail diaphaneity dazzling structure as claimed in claim 1, wherein, each of said light convergence areas is a conic or arc shape.

5. An automobile exhaust pipe tail diaphaneity dazzling structure as claimed in claim 1, wherein, both ends of each of said light convergence areas are separately formed with a gap at where said light convergence area breaks away from the wall of said outer tube.
